(19) United States
(12) Patent Application Publication
(10) Pub. No.: US 2010/0084860 A1
(43) Pub. Date: Apr. 8, 2010

(54) PIPE FITTING, PARTICULARLY FOR AIR CONDITIONING, CONDITIONING AND REFRIGERATION SYSTEMS

(76) Inventors: Gianluca Cariccia, Cigliano (IT); Marco Citelli, Pavone Canavese (IT); Gianluca Dolente, Alba Adriatica (IT); Vicenzo Salvia, Colli Del Tronto (IT)

Correspondence Address: Modiano & Associati, Via Meravigli 16, Milano, 20123, IT

(21) Appl. No.: 12/449,890

(22) PCT Filed: Mar. 8, 2007
(86) PCT No.: PCT/IT2007/000172

§ 371 Date: Sep. 2, 2009

(51) Int. Cl. F16L 33/18

(52) U.S. Cl. 285/256

(57) ABSTRACT

A pipe fitting for rubber hoses, of the type with a thermoplastic substrate, particularly for air conditioning, conditioning and refrigeration systems, particularly for vehicles and the like, comprising a rigid insert which is adapted to be inserted in a hose to be connected, and a bell-shaped element which is adapted to be crimped around the hose, its particularity consisting in that it comprises a double-adhesive solution which is arranged on the outer surface of said rigid insert and is adapted to produce adhesion between said rigid insert and said thermoplastic material of said internal layer of the rubber hose.

The present invention relates to a pipe fitting, particularly for air conditioning, conditioning and refrigeration systems, particularly for vehicles.

### BACKGROUND OF THE INVENTION

As is known, current attention is increasingly directed toward reducing the greenhouse effect, and this compels to search continuously for innovative solutions for fluid conveyance lines aimed at reducing the leaks from such lines. In particular, a key point of the fitting is the connection interface between rubber hoses (which predominantly have a substrate, i.e., the innermost layer, made of thermoplastic material) and rigid lines (predominantly metallic).

As is known, the flexible lines of air conditioning, refrigeration and conditioning systems typically use low-permeability hoses with a substrate made of thermoplastic material.

In these cases, in order to ensure tightness with respect to the refrigerating gas in the interface between the hose and the fitting it is possible to use two separate technologies:

a solution with sealing ring or rings made of elastomeric material, known as “seal obtained by elastic rings”;

an adhesive solution applied to the insert, which acts as a filler at the interface between the hose and the fitting, adhering to the rigid insert, but not to the internal surface of the hose, known as “seal by filler solution”.

FIG. 1 illustrates the first solution, i.e., the solution in which one or more elastic rings 3 are interposed between the rubber hose 1 and the rigid insert 2 and are thus interposed between the rigid insert 2 and the internal surface of the hose 1.

The seal provided by means of elastic rings has the advantage of being stronger and more reliable than the solution provided by means of adhesive, since the elastic reaction of these components under deformation is such as to compensate over time the natural deterioration of the elastic properties of the rubber hose wall.

However, the drawback is that the gas permeates through the elastic ring 3 toward the outside environment.

The seal provided by means of an adhesive solution, shown in FIG. 2, in which an adhesive solution 4 is arranged between the hose 1 and the rigid insert 2, substantially in the insert 2, has the advantage of saturating the microporosities at the interface between the hose 1 and the rigid insert 2, and since such interface extends along most of the contact surface, gas tightness is greater than with the elastic rings 3 of the preceding solution.

However, since there is no adhesion between the adhesive solution 4 and the inner thermoplastic layer of the rubber hose 1, over time the natural degradation of the elastic properties of the wall of the hose entails a reduced sealing compression at the interface, until the adhesive solution 4 partially separates from the wall of the rubber hose 1, causing leakage of gas from the duct.

### SUMMARY OF THE INVENTION

The aim of the present invention is to provide a pipe fitting, particularly for air conditioning, conditioning and refrigeration systems, which offers high tightness for the gases inside the duct and ensures reliability of the fitting over time.

Within this aim, an object of the present invention is to provide a pipe fitting which avoids the permeability of the gas from the hose due to the aging of the hose and therefore due to the natural degradation of the elastic properties of the wall of the rubber hose.

Another object of the present invention is to provide a pipe fitting in which the cost of the assembly obtained by the coupling of a hose is lower than that of the solution with elastic rings.

Still another object of the present invention is to provide a pipe fitting which is highly reliable, relatively simple to provide and at competitive costs.

This aim and these and other objects, which will become better apparent hereinafter, are achieved by a pipe fitting for rubber hoses, of the type with a thermoplastic substrate, particularly for air conditioning, conditioning and refrigeration systems, particularly for vehicles and the like, which comprises a rigid insert which is adapted to be inserted in a hose to be connected, and a bell-shaped element which is adapted to be crimped around said hose, characterized in that it comprises a double-adhesive solution which is arranged on the outer surface of said rigid insert and is adapted to produce adhesion between said rigid insert and said thermoplastic material of said internal layer of the rubber hose.

### BRIEF DESCRIPTION OF THE DRAWINGS

Further characteristics and advantages of the invention will become better apparent from the description of a preferred but not exclusive embodiment of the fitting according to the present invention, illustrated by way of non-limiting example in the accompanying drawings, wherein:

FIG. 1 is a sectional perspective view of a fitting according to the prior art;

FIG. 2 is a sectional perspective view of a fitting according to a second solution of the prior art;

FIG. 3 is a sectional perspective view of the fitting according to the present invention.

### DESCRIPTION OF THE PREFERRED EMBODIMENTS

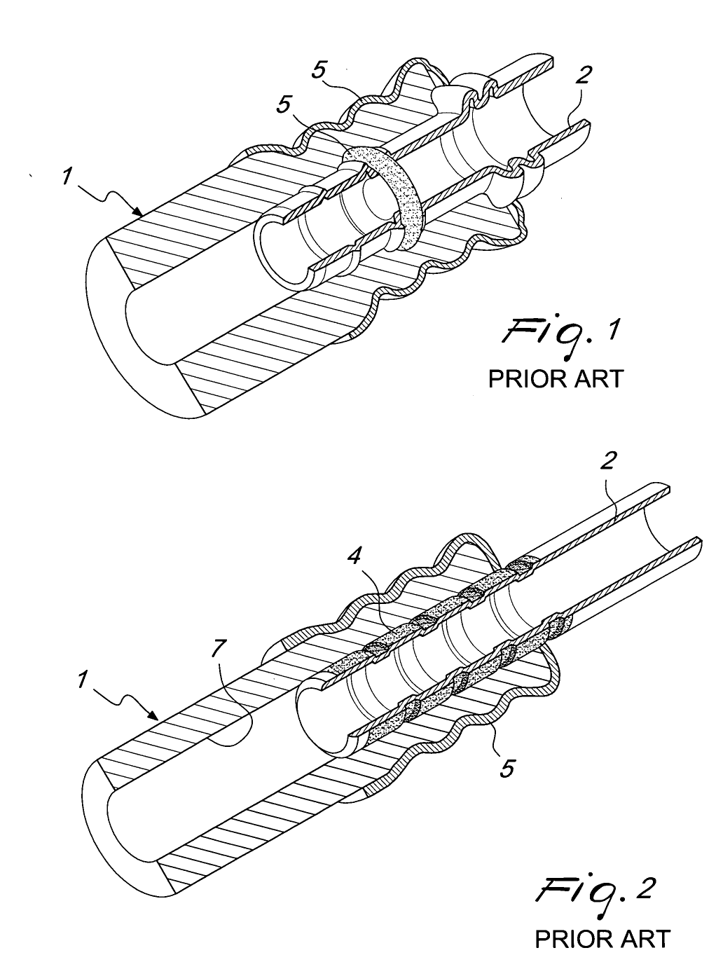

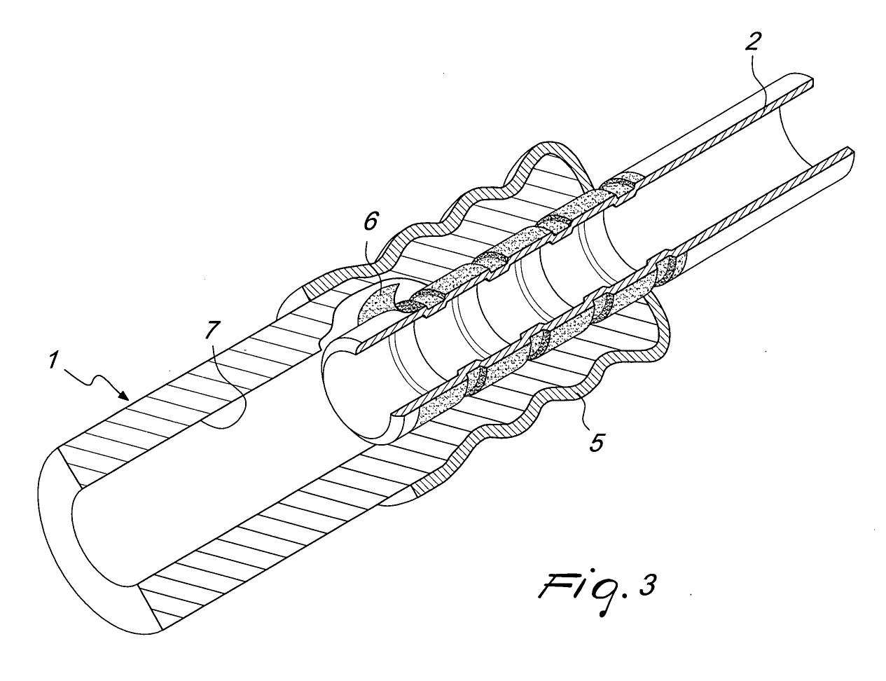

With reference only to FIG. 3, since FIGS. 1 and 2 have already been described and discussed previously, and using identical reference numerals for identical elements in all the figures, the fitting according to the present invention comprises, for a hose 1 with a rigid insert 2 with a corresponding bell-shaped element 5, the use of a double-adhesive solution 6 which is arranged on the surface of the rigid insert 2 and is capable of creating adhesion with both interfaces, i.e., the surface of the rigid insert 2 and the internal surface 7 of the rubber hose 1, with a substrate made of thermoplastic material.

The fact that a double-adhesive solution 6 is used combines the advantages of both solutions of the prior art described earlier, since it allows high gas tightness inside the duct and at the same time allows reliable durability, since thanks to the adhesion with both surfaces the hose 1 and the insert 2 become monolithic (regardless of the natural degradation of the elastic properties of the wall of the rubber hose).

Conveniently, merely by way of non-limiting indication it is possible to mention, as a double adhesive, a slow-polymerization solution (at least 6÷12 hours at ambient temperature) containing phenolic resins, formaldehyde copolymer, vinyl acetate, acrylic copolymer, xylene, ethyl benzene, isopropyl alcohol, methanol, methyl ethyl ketone, ethanol and the like.

Adhesion with the thermoplastic substrate of the rubber hose 1 occurs due to the combination of two factors:

the pressure generated during the crimping of the fitting and

the subsequent retention at a preset time and temperature (for example one day at ambient temperature).

Therefore, the fitting according to the invention allows to provide a sealing system which reduces the level of leakage of refrigerant gas of thermal conditioning systems, and allows to do so over the entire life cycle of the product and at the same time allows to reduce further the cost of an assembly with respect to the solution with elastic rings described earlier.

In practice it has been found that the fitting according to the present invention fully achieves the intended aim and objects, since it allows to reduce noxious emissions into the atmosphere and at the same time allows to reduce costs.

The fitting thus conceived is susceptible of numerous modifications and variations, all of which are within the scope of the inventive concept; all the details may further be replaced with other technically equivalent elements.

In practice, the materials used, as well as the contingent shapes and dimensions, may be any according to requirements and to the state of the art.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

What is claimed is:

1-3. (canceled)

4. A pipe fitting for rubber hoses, of the type with a thermoplastic substrate, particularly for air conditioning, conditioning and refrigeration systems, particularly for vehicles and the like, comprising a rigid insert which is adapted to be inserted in a hose to be connected, and a bell-shaped element which is adapted to be crimped around said hose, comprising a double-adhesive solution which is arranged on the outer surface of said rigid insert and is adapted to produce adhesion between said rigid insert and said thermoplastic material of said internal layer of the rubber hose.

5. The fitting according to claim 5, wherein said rigid insert and said rubber hose constitute a monolithic body thanks to the adhesion provided by said double-adhesive solution.

6. A method for connecting rubber hoses with a substrate made of thermoplastic material, comprising the steps that consist in:
providing a rigid insert;
providing a bell-shaped element which is adapted to be crimped onto said hose;
arranging a double-adhesive solution on the outer surface of said rigid insert;
crimping said fitting to said hose;
keeping said hose connected at a preset temperature for a preset time.
